(19) United States
(12) Patent Application Publication
(10) Pub. No.: US 2007/0218186 A1
(43) Pub. Date: Sep. 20, 2007

(54) Cooking process of walnut porridge of which discoloration is inhibited

(76) Inventors: Chang Yong Lee, Seoul (KR); Jong Wook Kim, Seoul (KR); Heon Woong Jung, Seoul (KR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/635,102

(22) Filed: Dec. 7, 2006

(30) Foreign Application Priority Data
Dec. 9, 2005 (KR) 10-2005-0120705

(51) Int. Cl. A23L 1/00

(52) U.S. Cl. 426/618

(57) ABSTRACT

The present invention disclose a method for preventing discoloration of walnut during cooking by adding caustic soda, a cooking process of walnut porridge of which discoloration is inhibited, and walnut porridge prepared by the same. The addition of the caustic soda neutralizes tannic acid contained in the inner shell of the walnut causing discoloration of walnuts during cooking. The inventive walnut porridge retains the walnut's intrinsic color, having experienced the least discoloration into dark greyish color during cooking, and exhibits enhanced sensory attributes without losing its natural taste.

### CROSS-REFERENCE TO RELATED APPLICATIONS

This application claims benefit under 35 U.S.C. § 119 from Korean Patent Application No. 10-2005-0120705, filed on Dec. 9, 2005, the entire content of which is incorporated herein by reference.

### BACKGROUND OF THE INVENTION

1. Field of the Invention

The present invention relates in general to a method for preventing discoloration of walnut during cooking by adding caustic soda, a cooking process of walnut porridge of which discoloration is inhibited, and walnut porridge prepared by the same. More specifically, the present invention relates to a method for preventing discoloration of walnut during cooking by adding caustic soda to neutralize tannic acid contained in an inner shell of the walnut, a cooking process of walnut porridge exhibiting enhanced sensory attributes in terms of color without losing its natural taste, and walnut porridge prepared by the same.

2. Description of the Related Art

In general, a walnut shell is divided into an outer portion (outer shell) and an inner portion (inner shell). As walnut meats have a lobed and wrinkled appearance, it is not easy to get rid of the inner shell (also called the pellicle) completely. The inner shell of the walnut contains a small amount of tannic acid. When walnut porridge is cooked, the tannic acid contained in the remaining inner shell reacts with Ca²⁺ in the walnut meat to produce a salt. This salt is known to make the color of walnut porridge dark. Therefore, a major problem of the conventional walnut porridge is that the walnut porridge turns to a dark greyish color as soon as it is heated, thereby substantially degrading the sensory quality of the walnut porridge.

### SUMMARY OF THE INVENTION

In view of the foregoing problems and a fact that tannic acid causes discoloration of walnuts during cooking, the inventors have carried out numerous experiments and studies for developing a cooking process for inhibiting the function (i.e., reducing acute toxicity) of tannic acid. Such attempts have taught that if walnut meats were treated with caustic soda before they are used for walnut porridge, discoloration of the walnut porridge to dark greyish color could be prevented without losing a natural taste of the walnut meats to ensure a high sensory quality of the walnut porridge. The inventors completed the present invention by confirming the aforementioned enhancements and features through a sensory test and chromaticity analysis.

It is, therefore, an object of the present invention to provide a method for preventing discoloration of walnut during cooking by adding caustic soda, a cooking process of walnut porridge of which discoloration is inhibited, and walnut porridge prepared by the same. The biggest and the most important characteristic of the present invention is its inhibition effect on discoloration of walnuts during cooking by neutralizing tannic acid in the remaining inner shells to thereby prevent salifying of the tannic acid. These effects are confirmed through a number of repeated sensory tests and chromaticity analyses on the walnut porridge of the invention, conducted by a team of professional sensory analysts.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a flow chart for sequentially describing a cooking process of walnut porridge of the present invention and retort processing operations thereof;

FIG. 2 is a graph showing results of a sensory test on walnut porridges according to various embodiments of the present invention; and

FIG. 3 is a graph showing results of a chromaticity analysis on walnut porridges according to various embodiments of the present invention; and

FIG. 4 shows coordinates in Hunter calorimeter.

### DETAILED DESCRIPTION OF THE PREFERRED EMBODIMENTS

Discoloration of walnuts during cooking is inhibited by adding caustic soda to walnuts covered by the pellicle. To ensure the effects, caustic soda is dissolved in water first before it is added to the walnuts to be crushed. The degree of discoloration effect of the walnuts during cooking is proportionally increased by the amount of caustic soda being added. Although the walnuts may retain their intrinsic milk white color, an excessive amount of the caustic soda can degrade the natural taste of walnuts. Preferably, 0.2 to 0.6 g of caustic soda is added with respect of 10 g of the walnuts covered by the pellicle (or inner shells). Since this range is set on the basis of the walnuts covered by the pellicle, the amount of caustic soda to be added is varied flexibly depending on how much pellicles remain.

The inventive cooking process of walnut porridge of which discoloration is inhibited includes the following steps.

1^{st} step: Remove outer shells of walnuts, and crush the walnuts together with caustic soda in aqueous solution; and

2^{nd} step: Mix the crushed walnut juice with rice or glutinous rice and water, and simmer them while stirring frequently until tender as walnut porridge.

In the 1^{st} step, the mixing ratio of walnuts: caustic soda: water is desirably 10: 0.2-0.6: 50-200 parts by weight.

Moreover, in the 2^{nd} step, the mixing ratio of crushed walnut juice: rice (or glutinous rice) : water is preferably 10-30: 30-100: 50-200 parts by weight, more preferably 10-30: 50-70: 70-120 parts by weight, and most preferably 20: 65: 95 parts by weight. Even though the mixing ratio may be variably modified as long as discoloration of walnuts does not occur, it is recommended to keep the limit in viewpoint of sensory quality.

The rice or the glutinous rice is usually soaked in water for a certain period of time before it is used for cooking walnut porridge.

In addition, in the 2^{nd} step, the mixture of the crushed walnut juice, rice or glutinous rice, and water is preferably simmered and stirred at 80-100° C. for 5 to 30 minutes, more preferably at 90-100° C. for 5 to 15 minutes, and most preferably at 95° C. for 10 minutes.

The walnut porridge thusly prepared experiences the least discoloration, so it retains the walnut's original milk white color and natural taste. The walnut porridge of the present invention can be processed as a ready-to-eat food, e.g., a retort pouch food that can be served simply after reheating in microwave or after simmering in water. The retort process includes: (1) filling the walnut porridge into a retort pouch (heat-resistant vessel or equipment), sealing and packaging; and (2) sterilizing the sealed retort pouch at high temperature, or performing a retort sterilization process, to thereby produce retort walnut porridge. Preferably, the retort sterilization process is performed at a temperature of 110° C. to 125° C. for 25 to 35 minutes. The retort walnut porridge provides an enhanced food safety against microbial spoilage, and an extended shelf life longer than 12 months at room temperature.

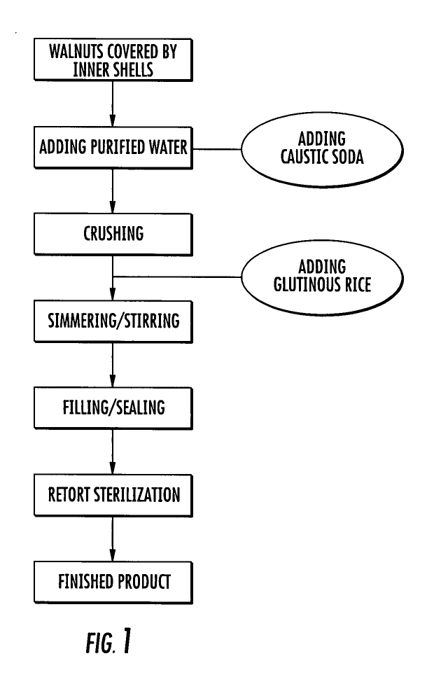

The cooking process of walnut porridge of the present invention and retort processing operations thereof are described sequentially in FIG. 1.

Preferred examples described hereinafter are nothing but the ones provided to assist in a comprehensive understanding of the invention. Thus, it is apparent that the present invention is not limited thereto.

### EXAMPLE 1

10 g of walnuts covered by inner shells (pellicles) having been removed of hard outer shells were put in 100 g of water and crushed to obtain crushed walnut juice.

### EXAMPLE 2

10 g of walnuts covered by inner shells (pellicles) having been removed of hard outer shells were put in a mixed solution of 0.2 g of caustic soda and 100 g of water, and crushed to obtain crushed walnut juice.

### EXAMPLE 3

The process used in Example 2 was carried out except that 0.4 g of caustic soda was used.

### EXAMPLE 4

The process used in Example 2 was carried out except that 0.8 g of caustic soda was used.

### EXAMPLE 5

The process used in Example 2 was carried out except that 1.2 g of caustic soda was used.

20 g of each of the crushed walnut juice samples obtained through Examples 1-5 was mixed with 65 g of rice and 95 g of water, and simmered and stirred at 95° C. for 10 minutes. 180 g of each sample was then put in a retort pouch (heat-resistant vessel) and sealed. Next, the samples were subjected to the retort sterilization process that is carried out in hot water of 110° C. to 125° C. for 25 to 35 minutes and cooled, to thereby produce walnut porridges.

### Experimental Example 1

### Sensory Test

TABLE 1

| | Exp. 1 | Exp. 2 | Exp. 3 | Exp. 4 | Exp. 5 |
|---|---|---|---|---|---|
| Color | 3.2 | 3.41 | 3.85 | 3.9 | 3.91 |
| p-value | 0.022 | 0.031 | 0.023 | 0.021 | 0.035 |
| Mild taste | 3.8 | 3.85 | 3.81 | 3.7 | 3.67 |
| p-value | 0.031 | 0.025 | 0.062 | 0.241 | 0.084 |
| Smooth and light taste | 3.8 | 3.82 | 3.75 | 3.6 | 3.5 |
| p-value | 0.028 | 0.052 | 0.125 | 0.248 | 0.01 |
| Thick and puckery taste | 3.81 | 3.85 | 3.81 | 3.67 | 3.52 |
| p-value | 0.017 | 0.024 | 0.036 | 0.045 | 0.04 |
| Aftertaste | 3.84 | 3.8 | 3.83 | 3.62 | 3.47 |
| p-value | 0.035 | 0.031 | 0.026 | 0.044 | 0.025 |
| Overall taste | 3.7 | 3.75 | 3.9 | 3.68 | 3.54 |
| (including color) | | | | | |
| p-value | 0.021 | 0.013 | 0.038 | 0.035 | 0.01 |

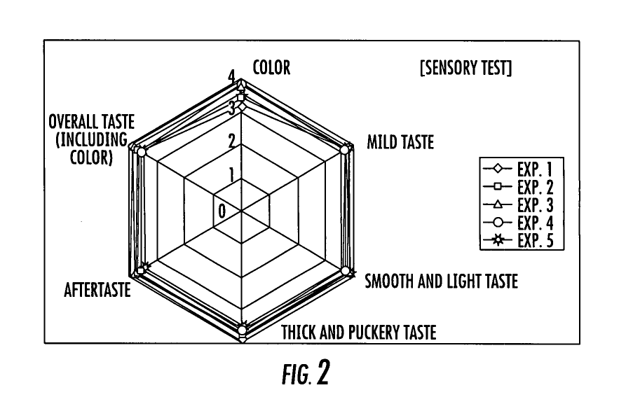

The sensory test results were expressed ranging from a low of 1 to a high of 5 (5: Excellent; 4: Good, 3: Fair, 2: Poor, 1: Very poor), and significant difference was in 95% CI. These results are plotted on the graph shown in FIG. 2.

As evident from the results, Example 1 where walnut porridge was cooked without caustic soda had dark greyish color, showing negative sensory attributes. On the other hand, Examples 2 to 5 where walnut porridges were cooked with caustic soda did not show the sensory problem that causes discoloration. Moreover, the satisfaction or the discoloration inhibition effect was increased proportionally to the amount of caustic soda being added. However, if a greater amount of caustic soda than a predetermined level was added, the walnut porridges had thick and puckery aftertastes and showed significantly poor taste qualities. These test results confirm that the discoloration of the walnut porridge can be resolved by adding caustic soda of which calcium reacts with tannic acid contained in the pellicle (inner shell) of the walnut and forms a salt, thereby inhibiting discoloration.

### Experimental Example 2

### Relation between Colors of Walnut Porridge and Addition of Caustic Soda

TABLE 2

| | Exp. 1 | Exp. 2 | Exp. 3 | Exp. 4 | Exp. 5 |
|---|---|---|---|---|---|
| ΔL | 10.47 | 13.57 | 15.02 | 15.21 | 15.08 |
| a | 17.14 | 12.42 | 10.98 | 10.81 | 10.79 |
| b | 17.06 | 19.78 | 22.45 | 22.75 | 22.81 |

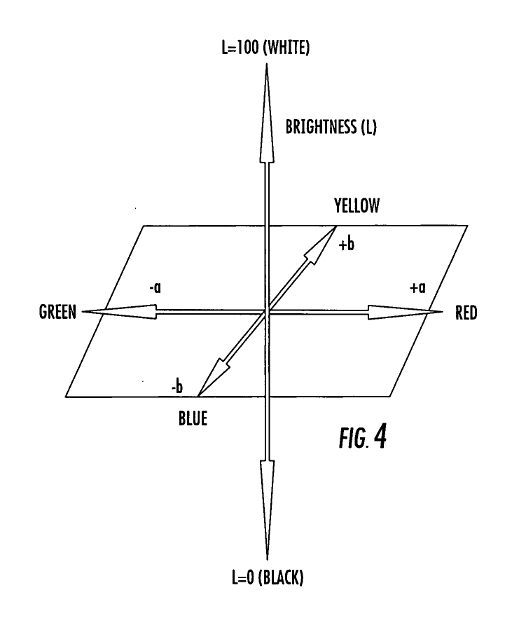

As illustrated in the Hunter calorimeter of FIG. 4, L values indicating luminosity (brightness) were plotted on the longitudinal axis; and ‘a’ and ‘b’ values indicating colors were plotted on the lateral axes to evaluate colors of the walnut porridges prepared by the respective Examples. In Table 2, ΔL indicates luminosity or brightness of color, ‘a’ indicates green and red, and ‘b’ indicates blue and yellow. As evident from Table 2, Example 1 where the walnut porridge was prepared without using caustic soda has the ΔL value noticeably lower than the ΔL values of the other Examples. Likewise, it turned out that Example 1 has the lowest ‘b’ value. Only in the ‘a’ value did Example 1 show a relative higher value than other products prepared under different conditions.

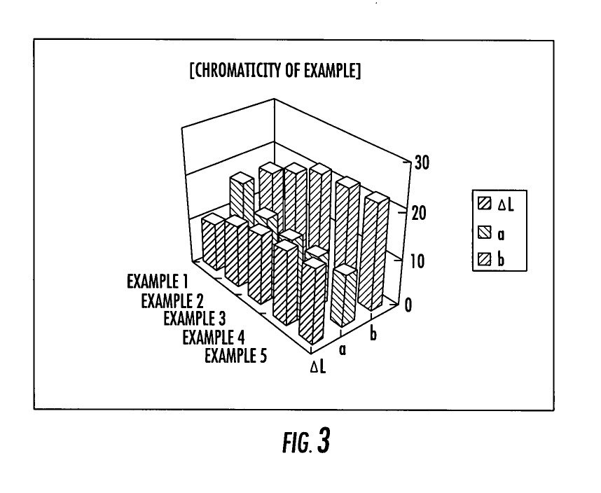

In short, the walnut porridge prepared without adding caustic soda turned to dark greyish color, and the results in Table 2 coincide with the sensory test results listed in Table 2. On the contrary, the walnut porridges prepared by adding a predetermined amount of caustic soda had the walnut's intrinsic milk white color. The experimental values, i.e., ΔL values and b values, of the walnut porridges with caustic soda were also higher than those of Example 1. To see more clearly, the results of Table 2 are graphically shown in FIG. 3.

From the results in Table 1 and Table 2, although the addition of caustic soda brought positive effects on the production of walnut porridges in terms of discoloration inhibition (for example, dark greyish color turned to milk white) and enhancement of sensory attributes in overall, there was no noticeable change in taste. One thing to notice in the test results of Examples 4 and 5 is that if caustic soda was added more than the recommended amount, the walnut porridge left thick and puckery aftertastes. Therefore, caustic soda content needs to be limited to 0.8 g or less.

As explained so far, the present invention relates to the method for preventing discoloration of walnut during cooking by adding caustic soda, the cooking process of walnut porridge of which discoloration is inhibited, and walnut porridge prepared by the same. The addition of the caustic soda neutralizes tannic acid contained in the inner shell of the walnut causing discoloration of walnuts during cooking. The present invention is a very useful invention in food industry in that the inventive walnut porridge retains the walnut's intrinsic color, having experienced the least discoloration into dark greyish color during cooking, and exhibits enhanced sensory attributes without losing its natural taste.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A cooking process of walnut porridge for preventing discoloration of walnuts by adding caustic soda to walnuts covered by inner shells.

2. A cooking process of walnut porridge of which discoloration is inhibited, comprising:
removing outer shells of walnuts, and crushing the walnuts together with caustic soda in aqueous solution; and
mixing the crushed walnut juice with rice (or glutinous rice) and water, and simmer them while stirring frequently until tender as walnut porridge.

3. Walnut porridge prepared by the cooking process recited in claim 2, of which discoloration is inhibited.
